(19) United States
(12) Patent Application Publication
(10) Pub. No.: US 2026/0171413 A1
(43) Pub. Date: Jun. 18, 2026

(54) ANODE MATERIAL, ANODE SHEET AND SECONDARY BATTERY

(71) Applicant: BTR NEW MATERIAL GROUP CO., LTD., Guangdong (CN)

(72) Inventors: RUIYANG WANG, Guangdong (CN); TAO XU, Guangdong (CN); XINGYANG LIU, Guangdong (CN); HAIHUI ZHOU, Guangdong (CN); PENG HE, Guangdong (CN); JIANGUO REN, Guangdong (CN); YOUYUAN HUANG, Guangdong (CN); XUEQIN HE, Guangdong (CN)

(21) Appl. No.: 19/405,964

(22) Filed: Dec. 2, 2025

(30) Foreign Application Priority Data
Dec. 16, 2024 (CN) 202411850893.9

(51) Int. Cl. H01M 4/587; H01M 4/02; H01M 4/36; H01M 10/0525

(52) U.S. Cl. CPC H01M 4/587; H01M 4/366; H01M 10/0525; H01M 2004/021; H01M 2004/027

(57) ABSTRACT

An anode material includes a core and a coating layer. The coating layer is located on a surface of the core, the core includes natural graphite and first amorphous carbon filled in pores of the natural graphite, and the coating layer includes second amorphous carbon. A Raman spectrum of the anode material has a D peak and a G peak, and an intensity ratio of the D peak to the G peak is I_{D}/I_{G}. The core includes an inner layer region and an outer layer region outside the inner layer region, and the outer layer region is closely adjacent to the coating layer. An average value of I_{D}/I_{G} in the inner layer region is Kₐ, and an average ratio of I_{D}/I_{G} values of the inner layer region to the outer layer region is K, which satisfy: 0.4≤Kₐ≤0.7, and 0.5≤K<0.9.

### CROSS-REFERENCE TO RELATED APPLICATION AND CLAIM OF PRIORITY

This application claims the benefit under 35 USC § 119 of Chinese Patent Application No. 202411850893.9, filed on Dec. 16, 2024, in the China Intellectual Property Office. The entire disclosure of said application is incorporated herein by reference for all purposes.

### BACKGROUND

### 1. Technical Field

The present application relates to the technical field of secondary batteries, and specifically relates to an anode material, an anode sheet and a secondary battery.

### 2. Background of the Invention

Due to the advantages of low self-discharge rate, high charge-discharge efficiency, no memory effect, long cycle life and the like, the lithium-ion battery is widely applied to the fields of 3C, power plants, energy storage devices and the like. The anode material is an important component of the lithium-ion battery, and the performance of the anode material directly influences the electrochemical performance of the lithium-ion battery. The natural anode material has gained wide attention due to the advantages of high specific capacity, low charge-discharge platform, low cost and the like. However, the natural graphite has high anisotropy and internal defects. During intercalation of lithium ions, volume expansion of the graphite is mainly shown as expansion in a thickness direction, and solvent molecules in the electrolyte will enter between graphite layers together with lithium ions, which may aggravate the expansion of the graphite. Also, the intercalation of the solvent molecules not only increases the volume of the graphite, but also leads to a solid electrolyte interphase (SEI) film not compact enough, thereby impairing the initial coulombic efficiency (ICE) of the battery.

### SUMMARY OF THE INVENTION

One object of the present application is to provide an anode material, an anode sheet and a secondary battery which can solve the problem of achieving a balance between the expansion rate and the initial coulombic efficiency of the anode material in the existing art.

To achieve the above object, according to one aspect of the present application, there is provided an anode material comprising: a core comprising natural graphite having pores and first amorphous carbon filled in the pores; and a coating layer located on a surface of the core, the coating layer comprising second amorphous carbon, wherein a Raman spectrum of the anode material has a D peak and a G peak, and an intensity ratio of the D peak to the G peak is I_{D}/I_{G}; the core includes an inner layer region and an outer layer region outside the inner layer region, and the outer layer region is closely adjacent to the coating layer; and an average value of I_{D}/I_{G} in the inner layer region is Kₐ, and an average ratio of I_{D}/I_{G} values of the inner layer region to the outer layer region is K, which satisfy: 0.4≤Kₐ≤0.7, and 0.5≤K<0.9.

Further, Ka satisfies: 0.41≤Ka≤0.68; or 0.4≤Ka≤0.6; or 0.45≤Ka≤0.7; or the value of Ka is 0.4, 0.41, 0.45, 0.5, 0.55, 0.6, 0.65, 0.68, 0.7, or a range defined by any two of the aforementioned values.

Further, K satisfies: 0.51≤K≤0.88; or 0.5≤K≤0.89; or 0.6≤K≤0.8; or the value of K is 0.5, 0.51, 0.6, 0.7, 0.8, 0.88, 0.89, or a range defined by any two of the aforementioned values.

Further, the core has a pore area percent φ satisfying: 2%≤φ≤5%.

Further, φ satisfies: 2%≤φ≤5%; or 3%≤φ≤5%; or 2%≤φ≤4%; or the value of φ is 2%, 2.5%, 3%, 4%, 4.5%, 5%, or a range defined by any two of the aforementioned values.

Further, the core includes a central region and an edge region located on the periphery of the central region; and an average ratio of pore area percents of the central region to the edge region is A, which satisfies: 1.2≤A≤2.0.

Further, A satisfies: 1.2≤A≤1.8; or 1.2≤A≤1.6; or 1.4≤A≤1.9; or the value of A is 1.2, 1.3, 1.4, 1.5, 1.6, 1.7, 1.8, 1.9, 2.0, or a range defined by any two of the aforementioned values.

Further, the anode material has a D50 particle size of 5 μm to 20 μm.

Further, the anode material has a shape including at least one of a spherical shape, an ellipsoidal shape, or a spheroidal shape.

Further, the anode material has a specific surface area of 2 m²/g to 5 m²/g.

Further, the anode material has a tap density of 0.9 g/cm³ to 1.4 g/cm³.

Further, the anode material has an average pore diameter of 10 nm to 20 nm.

Further, the thickness of the coating layer is 2 nm to 100 nm.

In a second aspect, the present application provides an anode sheet comprising: an anode current collector; and an anode material active layer comprising the anode material of the first aspect at least one surface of the anode current collector.

In a third aspect, the present application provides a secondary battery comprising: a cathode sheet; the anode sheet of the second aspect; and an isolation film between the cathode sheet and the anode sheet.

According to the technical solutions of the present application, the natural graphite has first amorphous carbon filled into pores and second amorphous carbon coated on a surface, thereby optimizing the microstructure of the material and improving the electrochemical performance of the material; and by defining that an average value of I_{D}/I_{G} in the inner layer region is Kₐ, and an average ratio of I_{D}/I_{G} values of the inner layer region to the outer layer region is K, which satisfy: 0.4≤Kₐ≤0.7, and 0.5≤K<0.9, it shows that the first amorphous carbon can enable densified filling and reasonable distribution of the D peak and the G peak, which can help to increase the intercalation and deintercalation efficiencies of lithium ions while effectively alleviating the volume expansion in the charge-discharge process, thereby extending the service life of the secondary battery. This anode material may be applied to a secondary battery to achieve an initial coulombic efficiency≥94%, and an electrode sheet expansion rate after 20 cycles≤25.7%.

### BRIEF DESCRIPTION OF THE DRAWINGS

FIG. 1 is a schematic diagram of a Raman mapping region in a section of an anode material particle according to an embodiment of the present application;

FIG. 2 is an SEM image showing a section topography of an anode material particle according to another embodiment of the present application.

FIG. 3 is a schematic structural diagram of a secondary battery according to an embodiment of the present application during charging.

FIG. 4 is a schematic structural diagram showing a secondary battery according to an embodiment of the present application during discharge.

### DETAIL DESCRIPTION OF THE INVENTION

To make the objects, examples, technical solutions and advantages of the present application clearer, the technical solutions in the examples of the application will be described clearly and completely below. The examples, if no specific condition specified, are carried out according to conventional conditions or conditions recommended by the manufacturer. The reagents or instruments used herein, if no manufacturer is specified, are conventional products commercially available.

As described in the background of the present application, the anode material in the existing art has the problems of high expansion rate and low initial coulombic efficiency. To solve the above problems, in an exemplary embodiment of the present application, there is provided an anode material, including a core and a coating layer. The coating layer is located on a surface of the core. The core includes natural graphite and first amorphous carbon filled in pores of the natural graphite. The coating layer includes second amorphous carbon. A Raman spectrum of the anode material has a D peak and a G peak, and an intensity ratio of the D peak to the G peak is I_{D}/I_{G}. The core includes an inner layer region and an outer layer region outside the inner layer region, and the outer layer region is closely adjacent to the coating layer. An average value of I_{D}/I_{G} in the inner layer region is Kₐ, and an average ratio of I_{D}/I_{G} values of the inner layer region to the outer layer region is K, which satisfy: 0.4≤Kₐ≤0.7, and 0.5≤K<0.9.

The anode material of the present application has a multi-layer composite structure including a core and a coating layer. The core includes natural graphite and first amorphous carbon filled in pores of the natural graphite. With the core filled with the first amorphous carbon and the surfaced coated with the second amorphous carbon, the structure of the anode material is significantly optimized. The coating layer includes second amorphous carbon covering on a surface of the core to form a protective film.

Specifically, on the one hand, the first amorphous carbon is a highly disordered carbon structure capable of filling internal pores of natural graphite, thereby effectively reducing the porosity and increasing the particle compactness. In addition, the filling with the first amorphous carbon can further reduce the anisotropy of the anode material so that lithium ions are more uniformly diffused in different directions, the diffusion rate of Li⁺ between graphite layers is increased, and the structural strain generated during the intercalation and deintercalation processes of Li⁺ is reduced, thereby reducing the expansion rate and improving the structural stability of the material. On the other hand, the coating with the second amorphous carbon helps to reduce direct contact between the natural graphite and the electrolyte to prevent solvent co-intercalation, while facilitating formation a stable and compact SEI film in the initial charge-discharge process, thereby improving the electrochemical stability and the initial coulombic efficiency of the material. TEM detection may be used to distinguish between the graphite core and the amorphous carbon.

A Raman spectrum of the anode material has a D peak and a G peak, and diffraction peaks and the corresponding peak intensities can be obtained through analysis of the Raman spectrum, where the D peak is at about 1350 cm⁻¹, and the G peak is at about 1580 cm⁻¹. The intensity of the D peak is related to the lattice defects, amorphous carbon, or disordered structure in the anode material, and the intensity of the G peak is related to the graphitization degree or ordering of the graphite material. The intensity ratio (I_{D}/I_{G}) of the D peak to the G peak is an important parameter for measuring the amorphous carbon distribution and the graphitization degree in the material, and reflects changes in the ordering of the internal structure and surface properties of particles in the anode material. A higher I_{D}/I_{G} value indicates more amorphous carbon or defect structures in the material, while a lower I_{D}/I_{G} value indicates a higher graphitization degree and a more ordered structure of the material.

The anode material includes a plurality of particles, the I_{D}/I_{G} in the inner layer region may be an arithmetic average value of I_{D}/I_{G} in inner layer regions of the plurality of particles, and the average ratio of I_{D}/I_{G} values of the inner layer region to the outer layer region may be an arithmetic average ratio of I_{D}/I_{G} values of inner layer regions to outer layer regions of the plurality of particles. The average value of I_{D}/I_{G} in the inner layer region is Kₐ, and the average ratio of I_{D}/I_{G} values of the inner layer region to the outer layer region is K, where Kₐ and K represent the overall structural property of the anode material.

A magnitude of the Kₐ value reflects an average degree of distribution of amorphous carbon in the inner layer region, and a structural defect state of the region. By limiting 0.4≤Kₐ≤0.7 a proper amount of amorphous carbon in the inner layer regions of the graphite particles can be ensured, and the amorphous carbon is filled into pores among graphite layers, so that volume expansion of the graphite in the charge-discharge process can be reduced, while the structural stability of the material is improved and peeling of graphite sheets is delayed, thereby improving the cycle life of the secondary battery. The appropriate range of the Kₐ value can facilitate formation of a more optimized SEI film on the surface and inside of the anode material. The stability of the SEI film will directly influence the initial coulombic efficiency, while the amorphous carbon in the inner layer region can promote formation of the SEI film, reduce decomposition of the electrolyte, and thereby improve the initial coulombic efficiency.

By limiting 0.5≤K<0.9, it indicates a difference in structure between the inner layer region and the outer layer region of the particle, where the inner layer region has a relatively high amorphous carbon content, and the outer layer region has a relatively low amorphous carbon content. It shows that pores in the inner layer region are filled with the first amorphous carbon, while the outer layer region keeps a certain degree of ordering. By optimizing the amorphous carbon distribution in the inner layer and in the outer layer, lithium ion diffusion rates in the inner layer region and the outer layer region can be ensured to be relatively balanced, thereby avoiding performance problems caused by an excessively high or low diffusion rate in the inner layer region. Further, this helps to reduce the lithium ion loss in the charge-discharge process, and improve the initial coulombic efficiency. In addition, this further facilitates control of the internal stress distribution of the material, and helps to reduce structural damage in the charge-discharge process as well as the risk of peeling graphite sheets, thereby improving the structural stability and cycle life of the material.

According to the research of the present application, the anode material described above may be applied to a secondary battery to improve the initial coulombic efficiency and reduce the expansion rate at the same time. The reason is that the natural graphite has first amorphous carbon filled into pores and second amorphous carbon coated on a surface, which optimize the microstructure of the material; and the average ratio of I_{D}/I_{G} values of the inner layer region to the outer layer region in the core, and the average value of I_{D}/I_{G} in the inner layer region, are limited. Such a special structure and limitations to I_{D}/I_{G} can ensure the overall structural stability of the material, enable smaller volume changes during intercalation and deintercalation of lithium ions, reduce peeling and expansion of graphite sheets, and reduce the expansion rate of the electrode sheet in the charge-discharge process. Meanwhile, uniform distribution of amorphous carbon on the surface and inside of the anode material can be ensured to form a stable SEI film, and the stable and uniformly distributed SEI film reduces direct contact between the electrolyte and the graphite, so that ineffective consumption of lithium ions in the initial charge-discharge process is reduced, while the initial coulombic efficiency is increased. This anode material may be applied to a secondary battery to achieve an initial coulombic efficiency≥93.5%, or further an initial coulombic efficiency≥94%, and an electrode sheet expansion rate after 20 cycles≤27.3%, or further an electrode sheet expansion rate after 20 cycles≤25.9%.

In some embodiments, Ka satisfies: 0.41≤Ka≤0.68, and K satisfies: 0.51≤K≤0.88. Further defining the value ranges of Ka and K is conducive to further improving the initial coulombic efficiency and reducing the expansion rate.

In some embodiments, Ka satisfies: 0.41≤Ka≤0.68; or, 0.4≤Ka≤0.6; or, 0.45≤Ka≤0.7; or, the value of Ka is 0.4, 0.41, 0.45, 0.5, 0.55, 0.6, 0.65, 0.68, 0.7, or a range defined by any two of the aforementioned values.

In other embodiments, K satisfies: 0.51≤K≤0.88; or, 0.5≤K≤0.89; or, 0.6≤K≤0.8; or, the value of K is 0.5, 0.51, 0.6, 0.7, 0.8, 0.88, 0.89, or a range defined by any two of the aforementioned values.

In the present application, the method for determining the inner layer region and the outer layer region of the core is as follows: select anode material particles, and select a rectangular region on the core section of the particles. Wherein, the center of the rectangular region is the center of the core section, or the center of the core section falls within the rectangular region. Preferably, the two endpoints along the length direction or the two endpoints on the diagonal of the rectangular region are located on the edge of the core section (i.e., enabling the outer layer region to be closely adjacent to the coating layer). In this way, it is ensured that the rectangular region can span the entire core section, so that the obtained data is both accurate and representative, which is conducive to analyzing the distribution of amorphous carbon at different depths. Divide the rectangular region into four equal parts in sequence along its length direction; the two middle parts are combined to account for 50% of the area of the rectangular region, which is the inner layer region, and the center of the core section falls within the inner layer region; the regions at both ends are combined to account for 50% of the area of the rectangular region, which is the outer layer region.

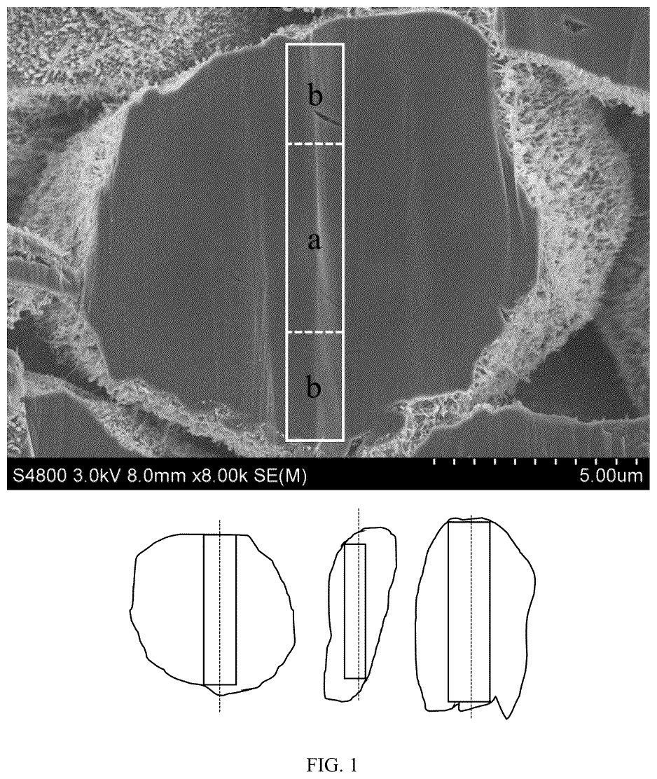

For example, in FIG. 1, a is the inner rectangular region and b is the outer rectangular region. The two outer rectangular regions are respectively located on both sides of the inner rectangular region, i.e., the outer rectangular regions are closely adjacent to the edges of the inner rectangular region, corresponding to the structural properties of the inner layer region and the outer layer region in the particle respectively. The distribution of amorphous carbon can be analyzed by comparing these two regions.

The rectangular region is provided to more accurately analyze the distribution of amorphous carbon at different depths of the anode material particles. In some embodiments, the rectangular region has a width of 1 μm to 6 μm and a length of 5 μm to 20 μm, so as to ensure that the width of the rectangular region is sufficiently small and the rectangular region does not exceed the outline range of the particle, thereby refining the detection of changes in the internal structure of the material.

Of course, in the particle sections of the anode material, there may be some particle sections where it is impossible to select a rectangular region with a width of 1 μm to 6 μm and a length of 5 μm to 20 μm due to issues with shape and size, or some particle sections where the rectangular region does not cover the center of the core section. In such cases, such particles are discarded in actual testing; instead, at least 15 particles for which the rectangular region of this size can be defined are randomly selected for testing, and the average value thereof can represent the condition of the anode material.

The test methods for Kₐ and K are not limited in the present application, and any conventional method in the field may be adopted as long as the anode material is ensured to meet the above requirements of the structure and parameters. For example, in some examples, Kₐ and K are obtained by the following steps:
S11, selecting n particles in an anode material, and selecting an i^{th} rectangular region on a core section of an i^{th} particle; where a center of the i^{th} rectangular region is a center of the core section or the center of the core section falls within the i^{th} rectangular region, 1≤i≤n, n≥15, and i and n are both positive integers;
S12, performing Raman mapping tests on all the defined rectangular regions. Among them, after arranging the obtained Raman mapping data in chronological order, the test data corresponding to the inner rectangular region a and the outer rectangular region b are determined according to the set scanning rules. For example, when the set scanning rule is to first scan horizontally and then scan layer by layer along the vertical direction, after arranging the Raman mapping data in chronological order, the first ¼ and the last ¼ of the data are regarded as the Raman data of the outer rectangular region b, and the middle part is regarded as the Raman data of the inner rectangular region a;
S13, acquiring I_{D}/I_{G} values of the inner rectangular region and the outer rectangular region of the i^{th} particle, denoted as Kₐᵢ and K_{bi}, respectively;
S14, calculating an average Kₐᵢ value of n particles to obtain an average value of I_{D}/I_{G} in the inner layer region, i.e., Kₐ;
S15, based on Kᵢ=Kₐᵢ/K_{bi}, calculating a Kᵢ value of the i^{th} particle; and
S16, calculating an average Kᵢ value of n particles, to obtain an average ratio of I_{D}/I_{G} values of the inner layer region to the outer layer region, i.e., K.

Specifically, in S11, n particles are randomly selected in the anode material, where n is a sufficiently large sample number, and is typically a positive integer≥15, to ensure statistical significance and representativeness of the analysis results. Then, an i^{th} particle may be cut by slicing or by an ion beam to expose a core section of the i^{th} particle, and an i^{th} rectangular region is selected on the core section. A center of the i^{th} rectangular region is defined as a geometric center of the core section, which means that this region covers a center position of the particle. Such a selection ensures the representativeness of the analyzed region, and can reflect properties of the core of the particle. The i value is a positive integer ranging from 1 to m.

In S12, the selected i^{th} rectangular region is further divided into three parts along a length direction thereof: one inner rectangular region and two outer rectangular regions. For example, in FIG. 1, a is the inner rectangular region and b is the outer rectangular region. The two outer rectangular regions are respectively located at two sides of the inner rectangular region. In other words, the outer rectangular regions are closely adjacent to edges of the inner rectangular region, and correspond to the structural properties of the inner layer region and the outer layer region in the particle, respectively, and the distribution condition of the amorphous carbon can be analyzed by comparing the two regions.

In S13, a Raman spectroscopy technique is used to scan the inner rectangular region and the outer rectangular region of the i^{th} particle, respectively, to acquire Raman spectrum data of the two types of regions; and from the Raman spectrum, intensities of a D peak and a G peak can be extracted, and I_{D}/I_{G} values can be calculated and designated as a Kₐᵢ (the I_{D}/I_{G} value of the inner layer region of the i^{th} particle) and a K_{bi} (the I_{D}/I_{G} value of the outer layer region of the i^{th} particle), respectively.

In S14, I_{D}/I_{G} values of inner rectangular regions of then particles are averaged to obtain a Kₐ value, which represents an average value of I_{D}/I_{G} in the inner layer region of the anode material. A magnitude of the Kₐ value reflects a relative content of amorphous carbon in the inner layer region, and an average state of the structural disordering degree.

In S15, for each particle, based on Ki=Kₐᵢ/K_{bi}, a ratio of I_{D}/I_{G} values of the inner rectangular region to the outer rectangular region of the i^{th} particle, i.e., the Kᵢ value of the i^{th} particle, is calculated. This ratio can reflect a difference in structural properties between the inner and outer layer regions of the i^{th} particle.

In S16, the Kᵢ values of then particles are averaged to obtain the K value, which is an average ratio of I_{D}/I_{G} values of the inner rectangular region to the outer rectangular region. K reflects an average ratio of I_{D}/I_{G} values of the inner layer region to the outer layer region in the entire anode material, and represents a difference in attribute properties between the inner and outer layer regions of the particle.

The inner rectangular region represents an average state of the inner layer region of the particle, and the outer rectangular region represents an average state of the outer layer region of the particle. In some examples, a center of the inner rectangular region is a center of the core section, which ensures that the inner rectangular region is in the inner layer region of the particle, so that more precise evaluation of the filling uniformity of the amorphous carbon inside the particle can be implemented. In some examples, the inner rectangular region has a length equal to ½ of a length of the i^{th} rectangular region. This ensures a sufficient depth of the inner rectangular region to reach the internal structure of the particle, instead of just surface or near-surface regions.

In some examples, the core has a pore area percent φ satisfying: 2%≤φ≤5%. By controlling the pore area percent of the core between 2% and 5%, volume changes of the anode material in the charge-discharge process can be reduced to prevent the particles from breaking due to excessive expansion, so that the structural stability of the material is improved, which, in addition to further improving the initial coulombic efficiency and reducing the expansion rate, can help to construct a continuous conductive network, reduce the transmission resistance of electrons and lithium ions, and improve efficiency and safety of the secondary battery.

In other embodiments, φ satisfies: 2%≤φ≤5%; or, 3%≤φ≤5%; or, 2%≤φ≤4%; or, the value of φ is 2%, 2.5%, 3%, 4%, 4.5%, 5%, or a range defined by any two of the aforementioned values.

In some embodiments, the core includes a central region and an edge region located on the periphery of the central region; and an average ratio of pore area percents of the central region to the edge region is A, which satisfies: 1.2≤A≤2.0. By limiting the average ratio of pore area percents of the central region to the edge region, more uniform pore distribution can be achieved in the anode material, and uniform intercalation and deintercalation of lithium ions can be facilitated, so that local stress is reduced, and the structural stability and the initial coulombic efficiency are further improved. In addition, a proper pore area and uniform pore distribution can promote more efficient diffusion of lithium ions between graphite layers, thereby reducing the charge-discharge time, and improving the power density of the secondary battery.

In some embodiments, A satisfies: 1.2≤A≤1.8; or, 1.2≤A≤1.6; or, 1.4≤A≤1.9; or, the value of A is 1.2, 1.3, 1.4, 1.5, 1.6, 1.7, 1.8, 1.9, 2.0, or a range defined by any two of the aforementioned values.

In the present application, the method for determining the central region and the edge region located on the periphery of the central region is as follows: select anode material particles, and select a circular or elliptical region on the core section of the particles. Wherein, the intersection point of the transverse median line and the longitudinal median line of the core section of a single particle is taken as the center of the ellipse or circle; the major axis of the ellipse or circle is ½ the length of the transverse median line, and the minor axis is ½ the length of the longitudinal median line; the outline of the ellipse is taken as the boundary to divide the core section into a central region (a1) and an edge region (b1). Among them, the transverse median line is the longest horizontal diameter of the section in the test interface, and the longitudinal median line is perpendicular to the transverse median line, passes through the midpoint of the transverse median line, and intersects with the edge of the material section.

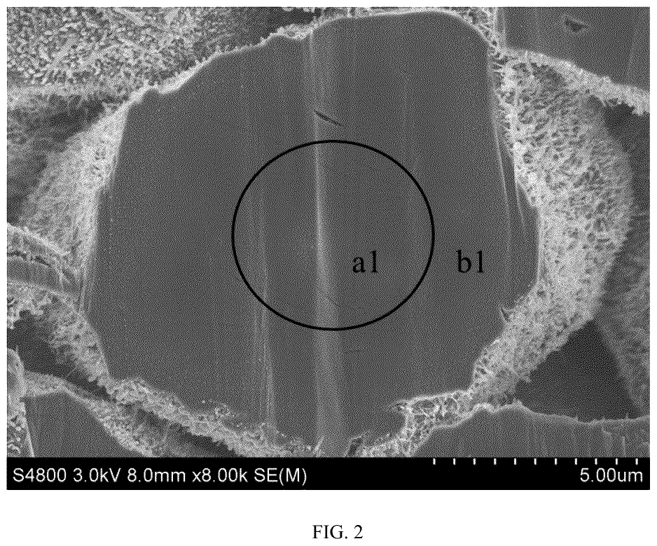

As shown in FIG. 2, the inner side of the outline of the ellipse is the central region (a1), and the outer side of the outline of the ellipse is the edge region (b1).

Through the selection of the above shape, the central region can be located at the center of the section as much as possible, and can be clearly distinguished from the edge region, thereby relatively accurately testing the pore area percent conditions of the central region and the edge region.

The central region represents an average state of the inner region of the particle, and the edge region represents an average state of the outer region of the particle. In some embodiments, the central region is circular or elliptical; the center of the central region is the intersection point of the transverse median line and the longitudinal median line of the core section; the definition of the central region ensures that the analysis range covers the central part of the core section of the particle.

In the present application, an exposed face obtained by cutting an anode material particle may be referred to as a section, through which internal structural features of the material can be exhibited. The section may be cut through a center of the particle in a direction perpendicular to a length or width direction of the particle. The section may be used for microstructure analysis by such as scanning electron microscopy (SEM), a Raman spectrometer, and the like.

The test methods for φ and A are not limited in the present application, and any conventional method in the field may be adopted as long as the anode material is ensured to meet the above requirements of the structure and parameters. In some examples, φ and A are obtained by the following steps:
S21, selecting m particles in an anode material, and selecting a core section of a j^{th} particle and defining it as a central region and an edge region; where the edge region is located at a periphery of the central region, 1≤j≤n, m≥20, and j and m are both positive integers;
S22, acquiring a pore area percent of the j^{th} particle, and pore area percents of the central region and the edge region, denoted as φⱼ, φₐⱼ and φ_{bj}, respectively;
S23, calculating an average φᵢ value of the m particles to obtain an area pore area percent φ of the core;
S24, based on Aⱼ=φₐⱼ/φ_{bj}, calculating an Aⱼ value of the j^{th} particle; and
S25, calculating an average Aⱼ value of the m particles to obtain an average ratio of pore area percents of the inner layer region to the outer layer region, i.e., A.

Specifically, in S21, m particles are randomly selected in the anode material, where m is a sufficiently large sample number to ensure representativeness of the statistical samples, and is typically a positive integer≥20. An j^{th} particle may be cut by slicing or by an ion beam to expose a core section of the j^{th} particle, which is then divided into two parts: one central region and one edge region. The edge region is located at a periphery of the central region, which can facilitate analysis of distribution conditions of pores in different regions to evaluate consistency of the internal structure of the material. The j value is a positive integer ranging from 1 to m.

In S22, a scanning electron microscope (SEM) image may be used, in which a pore area on the core section of the particle is identified and measured by a software tool, and then the pore area is divided by a total area of the core section of the whole particle to obtain a pore area percent of the j^{th} particle, i.e., φⱼ, which reflects the pore distribution of the whole particle. Similarly, a pore area of the central region is identified and measured, and then the pore area of the central region is divided by a total area of the central region to obtain a pore area percent of the central region of the j^{th} particle, i.e., φₐⱼ, which reflects the pore distribution of the central region; and a pore area of the edge region is identified and measured, and then the pore area of the edge region is divided by a total area of the edge region to obtain a pore area percent of the edge region of the j^{th} particle, i.e., φ_{bj}, which reflects the pore distribution of the edge region. It will be appreciated that a pore area of the j^{th} particle is equal to a sum of the pore areas of the central region and the edge region of the particle, and a total area of the j^{th} particle is equal to a sum of the areas of the central region and the edge region of the particle.

In S23, the φⱼ values of the m particles are averaged to obtain an area pore area percent of the core, i.e., φ, which reflects a pore area percent of the core in the entire anode material.

In S24, for each particle, based on Aⱼ=φₐⱼ/φ_{bj}, a ratio of pore area percents of the central region to the edge region of the j^{th} particle, i.e., the A^{j} value of the jth particle, is calculated. This ratio can reflect a difference in pore structural properties between the inner and outer layer regions of the j^{th} particle.

In S25, the Aⱼ values of them particles are averaged to obtain the A value, i.e., an average ratio of pore area percents of the central region to the edge region. A reflects an average ratio of pore area percents of the inner layer region to the outer layer region in the entire anode material, and represents a difference in attribute properties between the inner and outer layer regions of the particle.

The D50 particle size is a particle size at which the volume cumulative distribution percent in a sample reaches 50%, which reflects the average particle size of the anode material. In some examples, the anode material has a D50 particle size of 5 μm to 20 μm. By limiting the D50 particle size of the anode material in a proper range, in addition to further improving the initial coulombic efficiency of the secondary battery and reducing the expansion rate, the diffusion path of lithium ions is shortened, which can reduce the transmission resistance of the lithium ions in the intercalation and deintercalation processes, thereby improving the charge-discharge efficiency. In addition, internal pores of the electrode can be reduced, and the energy density of the secondary battery can be improved.

A regular particle shape contributes to the improvement of cycle stability and life of the secondary battery. In some examples, the anode material has a shape including at least one of a spherical shape, an ellipsoidal shape, or a spheroidal shape. The shape of the anode material actually refers to the shape of particles in the anode material, and by limiting the shape of the anode material, more uniform transmission paths for electrons and lithium ions can be formed, so that local stress concentration is reduced, and the power density of the secondary battery is improved.

The specific surface area (SSA) refers to a sum of surface areas per mass of material. In some examples, the anode material has a specific surface area of 2 m²/g to 5 m²/g. By limiting the specific surface area of the anode material in a proper range, in addition to further improving the initial coulombic efficiency and reducing the expansion rate, a proper diffusion path can be provided so that performance degradation caused by the electrolyte penetrating into the pores in the material is avoided, and lithium ions can be rapidly and uniformly diffused in the charge-discharge process, thereby improving the rate capability and cycle stability of the secondary battery. In addition, the contact between the electrolyte and the surface of the graphite material can be reduced so that the probability of side reactions, such as electrolyte decomposition, solvent molecule co-intercalation and the like, can be reduced.

The tap density (Tap) refers to a compactness degree of a material under physical vibration. In some examples, the anode material has a tap density of 0.9 g/cm³ to 1.4 g/cm³. By limiting the tap density of the anode material in a proper range, the compaction density of the material in the manufacturing process of the electrode can be improved, so that internal pores of the electrode are reduced, and the utilization rate of the anode material and the energy density of the secondary battery are increased. Meanwhile, a contact area between the electrolyte and graphite particles can be reduced, so that formation of the SEI film is reduced, the irreversible capacity in the initial charge-discharge process is reduced, and the initial coulombic efficiency is further increased. Further, the volume expansion in the circulation process can be reduced to reduce the mechanical stress between particles, thereby avoiding the formation of cracks. In addition, the structural integrity of the electrode can be maintained, and active substances are prevented from peeling off a current collector, thereby improving the cycle performance.

In some examples, the anode material has an average pore diameter of 10 nm to 20 nm. By limiting the average pore diameter of the anode material in the above range, first, lithium ions can be more uniformly intercalated into the graphite layer in the initial charge-discharge process, so that a stable and compact SEI film can be formed, and the initial coulombic efficiency is further increased. Second, the limited average pore diameter can reduce the volume change of the material during intercalation and deintercalation of lithium ions, and further reduce the expansion rate of graphite particles in the charge-discharge processes, so that the stability of the material structure is improved, the stress accumulation in the secondary battery is reduced, and the service life of the secondary battery is extended. In addition, the lithium ions can be diffused among graphite layers more easily and quickly, thereby increasing the charge-discharge speed and reducing the charge-discharge time.

In some examples, the core has an average particle size of 5 μm to 20 μm; and the coating layer has a thickness of 2 nm to 100 nm. Controlling the thickness of the coating layer within the above range is conducive to balancing the structural stability and electrochemical stability of the anode material, enabling batteries prepared with this anode material to have both good initial coulombic efficiency and low expansion rate.

In some examples, a mass ratio of the core to the coating layer is 100:(4 to 10), for example, 100:4, 100:5, 100:6, 100:7, 100:8, 100:9, 100:10, or in a range defined by any two of the aforementioned ratios. A mass ratio of the first amorphous carbon to the second amorphous carbon is (5 to 10):3, for example, 5:3, 6:3, 7:3, 8:3, 9:3, 10:3, or in a range defined by any two of the aforementioned ratios.

In some examples, the thickness of the coating layer is 2 nm to 100 nm. For example, the thickness of the coating layer is 2 nm, 5 nm, 10 nm, 20 nm, 30 nm, 40 nm, 50 nm, 60 nm, 70 nm, 80 nm, 90 nm, 100 nm, or the like, or other values within the range of 2 nm to 100 nm.

The anode material of the present application may be used as an anode material applied to a secondary battery, and can effectively improve the initial coulombic efficiency and reduce the expansion rate of the secondary battery. For example, in some examples, the anode material has an initial coulombic efficiency≥93.5%, or further an initial coulombic efficiency≥94%, and an electrode sheet expansion rate after 20 cycles≤27.3%, or further an electrode sheet expansion rate after 20 cycles≤25.9%, and a capacity≥362 mAh/g.

The specific preparation process of the anode material is not limited in the present application, as long as the above parameters are satisfied. In some examples, a preparation method for the anode material includes the following steps:
S1, sequentially performing first mixing and coating and first heat treatment on a graphite raw material and a first part of pitch to obtain a composite;
S2, performing isostatic pressing compaction on the composite, and then crushing the composite to obtain a first intermediate product;
S3, performing second mixing and coating on the first intermediate product and a second part of pitch to obtain a secondary coating;
S4, pressing the secondary coating to obtain a second intermediate product; and
S5, performing second heat treatment on the second intermediate product to obtain the anode material.

In S1, performing mixing and coating on the graphite raw material and the first part of pitch may be interpreted as that the graphite raw material and the pitch are mixed at a temperature corresponding to an pitch softening point, and in the first mixing and coating process, the first part of pitch is in a molten state and uniformly mixed with the graphite raw material to obtain a primary coating; and first heat treatment is performed on the primary coating so that the first part of pitch in the molten state is filled into pores in the graphite to obtain a composite. The compactness of the material can be improved through the mixing and coating and the first heat treatment. The graphite raw material may be spherical graphite with a D50 particle size of 1 μm to 20 μm.

The specific mixing ratio of the graphite raw material to the first part of pitch may be adjusted according to the material properties and requirements, and the first part of pitch is selected from at least one of petroleum pitch, coal pitch or mesophase pitch, with a D50 particle size of 2 mm to 3 mm. The softening point of the first part of pitch is 100° C. to 300° C., and it is to be understood that the mixing and coating is performed at a temperature of 100° C. to 300° C. for 10 minutes to 60 minutes. The first heat treatment may be performed in a first inert atmosphere at a temperature of 100° C. to 200° C. higher than the softening point of the pitch. The first inert atmosphere is provided to prevent oxidation of the material during the heat treatment, and any inert gas may be used to achieve this purpose, including at least one of nitrogen, helium or argon, for example. The first heat treatment is performed at a temperature of 200° C. to 600° C. for 3 h to 4 h.

In S2, isostatic pressing compaction is performed on the composite to obtain an isostatic pressing product, and then crushing the isostatic pressing product to obtain a first intermediate product. Internal filling is further realized through the isostatic pressing compaction, which can effectively reduce pores in the graphite, increase the material density, enhance the structural compactness, and improve the pore filling effect.

The specific pressure and time for the isostatic pressing may be optimized according to the performance requirements of the material and the capacity of the device. For example, in some examples, in the isostatic pressing, the filling effect of the pitch in the graphite may be controlled by controlling the pressure. For example, the isostatic pressing may be cold isostatic pressing or warm isostatic pressing at a pressure of 60 MPa to 120 MPa kept for 1 minute to 60 minutes.

In S3, performing second mixing and coating on the first intermediate product and a second part of pitch may be interpreted as that the first intermediate product and the second part of pitch are mixed at a temperature corresponding to an pitch softening point, and in the second mixing and coating process, the second part of pitch is in a molten state and uniformly mixed with the first intermediate product, so that the second part of pitch in the molten state is coated on a surface of the first intermediate product to obtain a secondary coating.

In some examples, a mass ratio of the graphite raw material to the pitch is 100:(8 to 12), for example, 100:8, 100:9, 100:10, 100:11, 100:12, or in a range defined by any two of the aforementioned ratios. A mass of the pitch is a sum of masses of the first part of pitch and the second part of pitch, and a mass ratio of the first part of pitch to the second part of pitch is (5 to 10):3, for example, 5:3, 6:3, 7:3, 8:3, 9:3, 10:3, or in a range defined by any two of the aforementioned ratios.

In S4, the secondary coating may be pressed by a hydraulic press to obtain a second intermediate product. The specific pressure, time and cycle number of the pressing may be adjusted according to the actual device capacity and material requirements. For example, in some examples, the pressing conditions are as follows: the hydraulic press is operated at a pressure of 10 MPa to 40 MPa kept for 0 to 2 min, and slowly reciprocates for 2 to 4 times after 0.5 minutes of pressure relief. The short dwell time can ensure rapid formation of a compact structure from the material at a high pressure, while avoiding device abrasion and production efficiency reduction caused by long dwell time, which is suitable for a continuous production process and can improve the production efficiency and the device utilization rate.

In S5, second heat treatment is performed on the second intermediate product in a second inert atmosphere, to ensure the graphitization degree of the material, and after the second heat treatment, the anode material is obtained by scattering, demagnetizing and screening. The first part of pitch filled into the pores in the graphite is converted into first amorphous carbon through the second heat treatment, and the second part of pitch coated on the surface is converted into second amorphous carbon, thereby obtaining the anode material with the special structure described above. The second heat treatment ensures stable carbonization of the material at a high temperature, and improves the graphitization degree of the material. Appropriate heat treatment temperature and time may affect the crystallinity and microstructure of graphite, so that the I_{D}/I_{G} in different regions meets the above requirements.

The specific temperature and time of the second heat treatment may be adjusted according to the conditions of the heat treatment apparatus and the performance target of the material. For example, in some examples, the second heat treatment is performed at a temperature higher than the first heat treatment. For example, the second heat treatment is performed at a temperature of 900° C. to 1500° C. for 1 h to 24 h. The second inert atmosphere is provided to prevent oxidation of the material during the heat treatment, and any inert gas may be used to achieve this purpose, including at least one of nitrogen, helium or argon, for example.

In a second aspect, the present application provides an anode sheet, including the anode material of the first aspect.

The anode sheet of the present application includes an anode current collector and an anode material active layer on at least one surface of the anode current collector. The anode material active layer includes the anode material of the first aspect. The anode current collector may use at least one of a copper foil, a nickel foil, a stainless steel foil, a titanium foil, or a carbon-based current collector, or the like, or may be any composite current collector disclosed in the existing art, for example, but not limited to, a current collector formed by combining the conductive foil described above and a polymer substrate. Due to the anode material with excellent performance contained therein, the anode sheet may be applied to a secondary battery to improve the initial coulombic efficiency and reduce the expansion rate of the secondary battery.

The anode material active layer further includes a binder for binding anode active substance particles to facilitate formation of a film layer, while improving the bonding between the anode material active layer and the anode current collector. In some examples, the binder may include, but is not limited to, polyvinyl alcohol, hydroxypropyl cellulose, diacetyl cellulose, polyvinyl chloride, carboxylated polyvinyl chloride, polyvinyl fluoride, ethylene oxide-containing polymers, polyvinyl pyrrolidone, polyurethane, polytetrafluoroethylene, polyvinylidene fluoride, polyethylene, polypropylene, styrene-butadiene rubber, acrylated styrene-butadiene rubber, epoxy resin, or nylon.

The anode material active layer may further include a conductive material including, but not limited to, a carbon-based material, a metal-based material, a conductive polymer, or any combination thereof. In some examples, the carbon-based material may include, but is not limited to, natural graphite, artificial graphite, carbon black, acetylene black, Ketjen black, carbon fibers, or any combination thereof. In some examples, the metal-based material may include, but is not limited to, metal powder or metal fibers, such as copper, nickel, aluminum, or silver. In some examples, the conductive polymer may be a polyphenylene derivative.

To prepare the anode sheet, the anode material, the conductive agent and the binder may be dispersed in a proper amount of solvent, and fully stirred and mixed to form uniform anode slurry; and the anode slurry is uniformly coated on the anode current collector, and then dried, rolled and slit to obtain the anode sheet. In a specific embodiment, the anode active layer includes 70% to 99% of the anode material, 0.5% to 15% of the conductive agent, and 0.5% to 15% of the binder by mass.

The conductive agent may be selected from at least one of natural graphite, artificial graphite, carbon black, acetylene black, Ketjen black, carbon fiber or graphene; and the binder may be selected from at least one of carboxymethyl cellulose, styrene-butadiene rubber, polyvinyl chloride, carboxylated polyvinyl chloride, polyvinyl fluoride, ethylene oxide-containing polymer, polyvinyl pyrrolidone, polyurethane, polytetrafluoroethylene, polyvinylidene fluoride, polyethylene, polypropylene, polyvinyl alcohol, or sodium polyacrylate.

In a third aspect, the present application provides a secondary battery, including the anode sheet of the second aspect.

Due to the anode sheet with excellent performance contained therein, the secondary battery has an excellent initial coulombic efficiency and a low expansion rate.

Specifically, the secondary battery includes a housing, an electrode assembly, and an electrolyte. The electrode assembly and the liquid electrolyte are both disposed in the housing.

The housing may be a package obtained by encapsulation using an encapsulation film (e.g., an aluminum-plastic film), such as the case of a pouch battery. In other examples, the battery may be a steel-cased battery, an aluminum-cased battery, or the like.

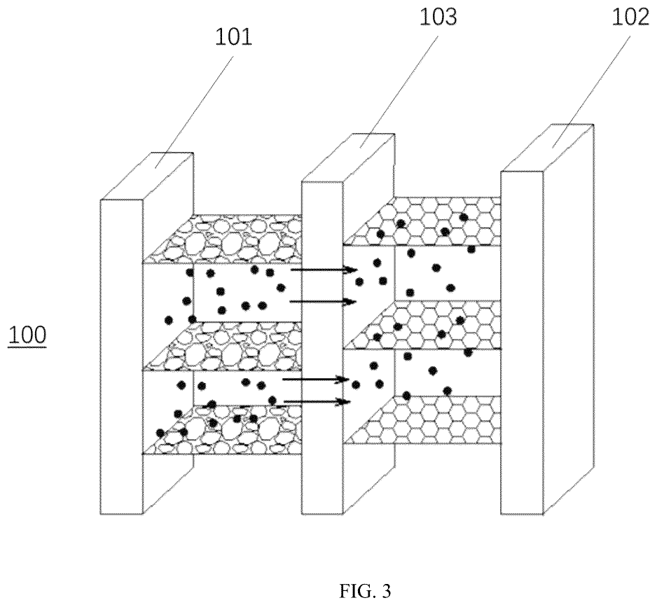

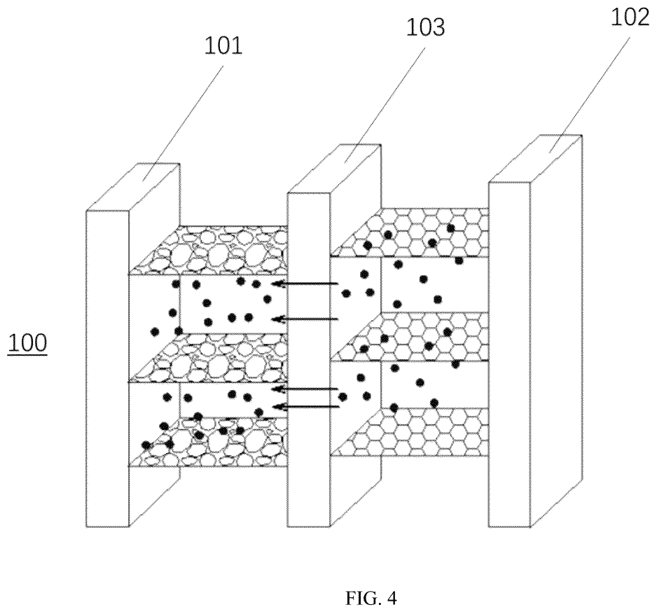

Referring to FIGS. 3 and 4, an electrode assembly 100 includes a cathode sheet 101, an anode sheet 102, and an isolation film 103 between the cathode sheet 101 and the anode sheet 102. The situation during charging may refer to FIG. 3, where active ions (e.g., lithium ions) are deintercalated from lattices of a cathode material (e.g., lithiated intercalation compound) of the cathode sheet 101, pass through the isolation film 103 through the liquid electrolyte, and then reach the anode sheet 102 before being inserted into lattices of an anode material. The situation during discharge may refer to FIG. 4, where active ions (e.g., lithium ions) are deintercalated from lattices of the anode material of the anode sheet 102, pass through the isolation film 103 through the liquid electrolyte, and reach the cathode sheet 101 before being intercalated into the lattices of the cathode material (e.g., lithiated intercalation compound), thereby generating electrons moving from the anode sheet 102 to the cathode sheet 101 through an external circuit. Reverse movement of the electrons forms current that may be used by an electrical appliance.

In some examples, the electrode assembly 100 may have a stacked structure formed by the cathode sheet 101, the isolation film 103, and the anode sheet 102 sequentially stacked. In other examples, the electrode assembly 100 may have a coiled structure formed by the cathode sheet 101, the isolation film 103, and the anode sheet 102 sequentially stacked and coiled.

The cathode sheet 101 includes a cathode current collector and a cathode material active layer on at least one surface of the cathode current collector. The cathode current collector may use an aluminum foil or a nickel foil or the like, or may be any composite current collector disclosed in the existing art, for example, but not limited to, a current collector formed by combining the conductive foil described above and a polymer substrate. The cathode material active layer includes a cathode active material including a compound that enables reversible intercalation and deintercalation of lithium icons (i.e., a lithiated intercalation compound). In some examples, the cathode active material may include a lithium transition metal composite oxide. The lithium transition metal composite oxide contains lithium and at least one element selected from cobalt, manganese, or nickel. In some examples, the cathode active material may include, but is not limited to, at least one of LiCoO₂, NCM, LiMn₂O₄, LiNi_{0.5}Mn_{1.5}O₄ or LiFePO₄.

The cathode material active layer further includes a binder for binding cathode active material particles to facilitate formation of a film layer, while improving the bonding between the cathode material active layer and the cathode current collector. In some examples, the binder may include, but is not limited to, at least one of polyvinyl alcohol, hydroxypropyl cellulose, diacetyl cellulose, polyvinyl chloride, carboxylated polyvinyl chloride, polyvinyl fluoride, ethylene oxide-containing polymers, polyvinyl pyrrolidone, polyurethane, polytetrafluoroethylene, polyvinylidene fluoride, polyethylene, polypropylene, styrene-butadiene rubber, acrylated styrene-butadiene rubber, epoxy resin, or nylon.

The cathode material active layer may further include a conductive material including, but not limited to, a carbon-based material, a metal-based material, a conductive polymer, or any combination thereof. In some examples, the carbon-based material may include, but is not limited to, natural graphite, artificial graphite, carbon black, acetylene black, Ketjen black, carbon fibers, or any combination thereof. In some examples, the metal-based material may include, but is not limited to, metal powder or metal fibers, such as copper, nickel, aluminum, or silver. In some examples, the conductive polymer may be a polyphenylene derivative.

The isolation film 103 includes a film layer having a porous structure made of a material including, but not limited to, at least one of polyethylene, polypropylene, polyvinylidene fluoride, polyethylene terephthalate, polyimide, or aramid. For example, the isolation film 103 may be a polypropylene porous membrane, a polyethylene porous membrane, a polypropylene nonwoven, a polyethylene nonwoven, or a polypropylene-polyethylene-polypropylene porous composite membrane.

The electrolyte has a function of conducting ions between the cathode sheet 101 and the anode sheet 102. The electrolyte may have a state including one or more of a gel state, a solid state, or a liquid state. In some embodiments, the electrolyte is a liquid electrolyte. The liquid electrolyte has a function of conducting active ions between the cathode sheet 101 and the anode sheet 102. In some examples, the liquid electrolyte includes a lithium salt and an organic solvent. The lithium salt may be selected from a group including, but not limited to, one or more of LiPF₆, LiBF₄, LiAsF₆, LiClO₄, LiB(C₆H₅)₄, LiCH₃SO₃, LiFSI, LiTFSI, LiCF₃SO₃, LiN(SO₂CF₃)₂, LiC(SO₂CF₃)₃, LiBOB or LiPO₂F₂. For example, LiPF₆ is selected as the lithium salt, because it enables a high ionic conductivity and improved cycle properties. The organic solvent may be a carbonate compound, a carboxylate ester compound, an ether compound, a nitrile compound, any other organic solvent, or any combination thereof. Instances of the carbonate compound include, but are not limited to, DEC, DMC, DPC, MPC, EPC, MEC, EC, PC, BC, VEC, FEC, 1,2-difluoroethylene carbonate, 1,1-difluoroethylene carbonate, 1,1,2-trifluoroethylene carbonate, 1,1,2,2-tetrafluoroethylene carbonate, 1-fluoro-2-methylethylene carbonate, 1-fluoro-1-methylethylene carbonate, 1,2-difluoro-1-methylethylene carbonate, 1,1,2-trifluoro-2-methylethylene carbonate, trifluoromethylethylene carbonate, or combinations thereof.

To prepare the secondary battery, the cathode sheet, the isolation film, and the anode sheet are wound or laminated to obtain a battery core, which is then packaged into an aluminum-plastic film punched and formed in advance. Then the packaged battery is dried and injected with electrolyte, and then placed, formed and sealed secondarily to complete preparation of the secondary battery.

The present application is described in further details below with reference to specific examples, which should not be construed as limiting the scope of the present application as claimed.

### Example 1

This example provides a preparation method for an anode material, which includes the following steps:
S1, adding 20 kg of a graphite raw material (with a D50 particle size of 16 μm) and 1.6 kg of pitch (with a softening point of 250° C.) into a VC mixer and mixing for 25 min, uniformly mixing, performing low-temperature heat treatment for 4 h at 400° C. in a nitrogen protection atmosphere, and cooling to room temperature to obtain a composite;
S2, performing isostatic pressing compaction on the composite at a maximum isostatic pressing pressure of 60 MPa for 15 min, and crushing the material to a size of about 16 μm to obtain a first intermediate product;
S3, adding the first intermediate product and 0.6 kg of pitch (with a softening point of 250° C.) into the VC mixer, and mixing for 25 minutes to obtain a secondary coating;
S4, pressing the secondary coating by a hydraulic press at a pressure of 30 MPa for 0.5 min, and reciprocating for 3 times to obtain a second intermediate product; and
S5, performing high-temperature heat treatment on the second intermediate product, carbonizing at 1250° C. for 16 h in a nitrogen protection atmosphere, and then scattering, demagnetizing and screening to obtain the anode material of this example.

### Example 2

This example provides a preparation method for an anode material, which includes the following steps:
S1, adding 20 kg of a graphite raw material (with a D50 particle size of 16 μm) and 1.6 kg of pitch (with a softening point of 180° C.) into a VC mixer and mixing for 25 min, uniformly mixing, performing low-temperature heat treatment for 4 h at 350° C. in a nitrogen protection atmosphere, and cooling to room temperature to obtain a composite;
S2, performing isostatic pressing compaction on the composite at a maximum isostatic pressing pressure of 50 MPa for 15 min, and crushing the material to a size of about 16 μm to obtain a first intermediate product;
S3, adding the first intermediate product and 0.6 kg of pitch (with a softening point of 180° C.) into the VC mixer, and mixing for 30 minutes to obtain a secondary coating;
S4, pressing the secondary coating by a hydraulic press at a pressure of 30 MPa for 0.5 min, and reciprocating for 3 times to obtain a second intermediate product; and
S5, performing high-temperature heat treatment on the second intermediate product, carbonizing at 1150° C. for 12 h in a nitrogen protection atmosphere, and then scattering, demagnetizing and screening to obtain the anode material of this example.

### Example 3

This example provides a preparation method for an anode material, which includes the following steps:
S1, adding 20 kg of a graphite raw material (with a D50 particle size of 16 μm) and 1.0 kg of pitch (with a softening point of 180° C.) into a VC mixer and mixing for 25 min, uniformly mixing, performing low-temperature heat treatment for 4 h at 350° C. in a nitrogen protection atmosphere, and cooling to room temperature to obtain a composite;
S2, performing isostatic pressing compaction on the composite at a maximum isostatic pressing pressure of 50 MPa for 15 min, and crushing the material to a size of about 16 μm to obtain a first intermediate product;
S3, adding the first intermediate product and 0.6 kg of pitch (with a softening point of 180° C.) into the VC mixer, and mixing for 25 minutes to obtain a first intermediate product;
S4, pressing the first intermediate product by a hydraulic press at a pressure of 25 MPa for 0.5 min, and reciprocating for 3 times to obtain a second intermediate product; and
S5, performing high-temperature heat treatment on the second intermediate product, carbonizing at 1150° C. for 10 h in a nitrogen protection atmosphere, and then scattering, demagnetizing and screening to obtain the anode material of this example.

### Example 4

This example provides a preparation method for an anode material, which includes the following steps:
S1, adding 20 kg of a graphite raw material (with a D50 particle size of 14.5 μm) and 1.6 kg of pitch (with a softening point of 250° C.) into a VC mixer and mixing for 25 min, uniformly mixing, performing low-temperature heat treatment for 4 h at 400° C. in a nitrogen protection atmosphere, and cooling to room temperature to obtain a composite;
S2, performing isostatic pressing compaction on the composite at a maximum isostatic pressing pressure of 70 MPa for 15 min, and crushing the material to a size of about 14.5 μm to obtain a first intermediate product;
S3, adding the first intermediate product and 0.6 kg of pitch (with a softening point of 250° C.) into the VC mixer, and mixing for 30 minutes to obtain a secondary coating;
S4, pressing the secondary coating by a hydraulic press at a pressure of 30 MPa for 0.5 min, reciprocating for 3 times and roughly breaking to obtain a second intermediate product; and
S5, performing high-temperature heat treatment on the second intermediate product, carbonizing at 1250° C. for 16 h in a nitrogen protection atmosphere, and then scattering, demagnetizing and screening to obtain the anode material of this example.

### Example 5

This example provides a preparation method for an anode material, which includes the following steps:
S1, adding 20 kg of a graphite raw material (with a D50 particle size of 12 μm) and 1.6 kg of pitch (with a softening point of 250° C.) into a VC mixer and mixing for 25 min, uniformly mixing, performing low-temperature heat treatment for 4 h at 400° C. in a nitrogen protection atmosphere, and cooling to room temperature to obtain a composite;
S2, performing isostatic pressing compaction on the composite at a maximum isostatic pressing pressure of 60 MPa for 15 min, and crushing the material to a size of about 12 μm to obtain a first intermediate product;
S3, adding the first intermediate product and 0.6 kg of pitch (with a softening point of 250° C.) into the VC mixer, and mixing for 30 minutes to obtain a secondary coating;
S4, pressing the secondary coating by a hydraulic press at a pressure of 30 MPa for 0.5 min, reciprocating for 3 times and roughly breaking to obtain a second intermediate product; and
S5, performing high-temperature heat treatment on the second intermediate product, carbonizing at 1250° C. for 14 h in a nitrogen protection atmosphere, and then scattering, demagnetizing and screening to obtain the anode material of this example.

### Example 6

This example provides a preparation method for an anode material, which includes the following steps:
S1, adding 20 kg of a graphite raw material (with a D50 particle size of 10 μm) and 1.6 kg of pitch (with a softening point of 250° C.) into a VC mixer and mixing for 25 min, uniformly mixing, performing low-temperature heat treatment for 4 h at 400° C. in a nitrogen protection atmosphere, and cooling to room temperature to obtain a composite;
S2, performing isostatic pressing compaction on the composite at a maximum isostatic pressing pressure of 60 MPa for 15 min, and crushing the material to a size of about 10 μm to obtain a first intermediate product;
S3, adding the first intermediate product and 0.6 kg of pitch (with a softening point of 250° C.) into the VC mixer, and mixing for 25 minutes to obtain a secondary coating;
S4, pressing the secondary coating by a hydraulic press at a pressure of 30 MPa for 0.5 min, reciprocating for 3 times and roughly breaking to obtain a second intermediate product; and
S5, performing high-temperature heat treatment on the second intermediate product, carbonizing at 1250° C. for 18 h in a nitrogen protection atmosphere, and then scattering, demagnetizing and screening to obtain the anode material of this example.

### Example 7

This example provides a preparation method for an anode material, which includes the following steps:
S1, adding 20 kg of a graphite raw material (with a D50 particle size of 16 μm) and 0.7 kg of pitch (with a softening point of 180° C.) into a VC mixer and mixing for 25 min, uniformly mixing, performing low-temperature heat treatment for 4 h at 350° C. in a nitrogen protection atmosphere, and cooling to room temperature to obtain a composite;
S2, performing isostatic pressing compaction on the composite at a maximum isostatic pressing pressure of 50 MPa for 15 min, and crushing the material to a size of about 16 μm to obtain a first intermediate product;
S3, adding the first intermediate product and 0.3 kg of pitch (with a softening point of 180° C.) into the VC mixer, and mixing for 25 minutes to obtain a first intermediate product;
S4, pressing the first intermediate product by a hydraulic press at a pressure of 25 MPa for 0.5 min, and reciprocating for 3 times to obtain a second intermediate product; and
S5, performing high-temperature heat treatment on the second intermediate product, carbonizing at 1150° C. for 12 h in a nitrogen protection atmosphere, and then scattering, demagnetizing and screening to obtain the anode material of this example.

### Example 8

This example provides a preparation method for an anode material, which includes the following steps:
S1, adding 20 kg of a graphite raw material (with a D50 particle size of 16 μm) and 2.0 kg of pitch (with a softening point of 180° C.) into a VC mixer and mixing for 25 min, uniformly mixing, performing low-temperature heat treatment for 4 h at 350° C. in a nitrogen protection atmosphere, and cooling to room temperature to obtain a composite;
S2, performing isostatic pressing compaction on the composite at a maximum isostatic pressing pressure of 50 MPa for 15 min, and crushing the material to a size of about 16 μm to obtain a first intermediate product;
S3, adding the first intermediate product and 1.0 kg of pitch (with a softening point of 180° C.) into the VC mixer, and mixing for 25 minutes to obtain a first intermediate product;
S4, pressing the first intermediate product by a hydraulic press at a pressure of 25 MPa for 0.5 min, and reciprocating for 3 times to obtain a second intermediate product; and
S5, performing high-temperature heat treatment on the second intermediate product, carbonizing at 1250° C. for 18 h in a nitrogen protection atmosphere, and then scattering, demagnetizing and screening to obtain the anode material of this example.

### Example 9

This example provides a preparation method for an anode material, which includes the following steps:
S1, adding 20 kg of a graphite raw material (with a D50 particle size of 16 μm) and 2.5 kg of pitch (with a softening point of 180° C.) into a VC mixer and mixing for 25 min, uniformly mixing, performing low-temperature heat treatment for 4 h at 350° C. in a nitrogen protection atmosphere, and cooling to room temperature to obtain a composite;
S2, performing isostatic pressing compaction on the composite at a maximum isostatic pressing pressure of 50 MPa for 15 min, and crushing the material to a size of about 16 μm to obtain a first intermediate product;
S3, adding the first intermediate product and 1.5 kg of pitch (with a softening point of 180° C.) into the VC mixer, and mixing for 25 minutes to obtain a first intermediate product;
S4, pressing the first intermediate product by a hydraulic press at a pressure of 25 MPa for 0.5 min, and reciprocating for 3 times to obtain a second intermediate product; and
S5, performing high-temperature heat treatment on the second intermediate product, carbonizing at 1250° C. for 18 h in a nitrogen protection atmosphere, and then scattering, demagnetizing and screening to obtain the anode material of this example.

### Comparative Example 1

This comparative example provides a preparation method for an anode material, which includes the following steps:
adding 20 kg of a graphite raw material (with a D50 particle size of 16 μm) and 2.2 kg of pitch (with a softening point of 250° C.) into a VC mixer and mixing for 25 min, after which carbonizing at 1250° C. for 16 h in a nitrogen protection atmosphere, and then scattering, demagnetizing and screening to obtain the anode material of this comparative example.

### Comparative Example 2

This comparative example provides a preparation method for an anode material, which includes the following steps:
adding 20 kg of a graphite raw material (with a D50 particle size of 16 μm), 2.25 kg of pitch (with a softening point of 250° C.), and 40 g of graphene powder into a VC mixer and mixing for 25 min, then performing heat treatment at 400° C. so that the pitch and the graphene powder are uniformly and closed attached to surfaces of the graphite particles, after which carbonizing at 1250° C. for 16 h in a nitrogen protection atmosphere, and then scattering, demagnetizing and screening to obtain the anode material of this comparative example.

### Comparative Example 3

This comparative example provides a preparation method for an anode material, which includes the following steps:
S1, performing isostatic pressing compaction on 20 kg of a graphite raw material (with a D50 particle size of 16 μm) at a maximum isostatic pressing pressure of 60 MPa for 15 min; and crushing the material, and then pressing the material by a hydraulic press at a pressure of 30 MPa for 0.5 min, and reciprocating for 3 times to crush the material into a size of about 16 μm to obtain a densified product; and
S2, adding the densified product and 2.2 kg of pitch (with a softening point of 250° C.) into a VC mixer, and mixing for 25 min, and then carbonizing at 1250° C. for 16 h in a nitrogen protection atmosphere, and then scattering, demagnetizing and screening to obtain the anode material of this comparative example.

### Test Examples

### 1. Test of Section Porosity

Particle samples of the anode material are milled by an ion mill (HITACHI E3500) by ionizing argon (Ar) into argon ions (Ar⁺) in a high-vacuum environment via an ion source, then accelerating the argon ions through a high-voltage electric field to make them obtain high energy to bombard the sample surface, thereby removing the material on the sample surface and achieving the effects of grinding and polishing, to make sections of the particles visible, and then placed under a high power electron microscope (HITACHI S4800) to observe the sections of the particles, where an amplification factor for a single particle is 2.5 kX to 9.0 kX to ensure that a complete section of a single particle is shown.

At least 20 particles are selected. An intersection point of a transverse median line and a longitudinal median line of a core section of the single particle is taken as a center of the ellipse, a length of a major axis of the ellipse is ½ of a length of the transverse median line, a length of a minor axis is ½ of a length of the longitudinal median line, and the core section is divided into a central region (a1) and an edge region (b1) by the ellipse's outline, where the inner side of the ellipse's outline is the central region (a1) and the outer side of the ellipse's outline is the edge region (b1), as shown in FIG. 2.

The aforementioned transverse median line is the longest horizontal diameter of the section, and the longitudinal median line is perpendicular to the transverse median line, passes through the midpoint of the transverse median line, and intersects the edge of the material section.

Software such as Image Pro Plus, Image J, and the Aztec Feature software is used to record and calculate a pore area percent φⱼ of the core section, a pore area percent φₐⱼ of the central region, a pore area percent φ_{bj} of the edge region, and a ratio (Aⱼ) of pore area percents of the central region to the edge region of a single particle, where φₐⱼ=central region pore area/central region area in section of an j^{th} particle*100%, φ_{bi}=edge region pore area/edge region area in section of the j^{th} particle*100%, and φⱼ=pore area of core section/core section area of the j^{th} particle*100%, and Aⱼ=φₐⱼ/φ_{bj}.

A pore area percent (φ) of the whole core section of the anode material, and an average ratio (A) of pore areas of the central region and the edge region to an area of the section are calculated by:

$$A = {φ}_{a} / {φ}_{b} = 1 / m ( {\sum }_{j = 1}^{m} ( {φ}_{aj} / {φ}_{bj} ) )$$

$$φ = 1 / m ( {\sum }_{j = 1}^{m} {φ}_{j} )$$

where m≥20 and 1≤j≤m, and j and m are positive integers.

Taking Image Pro Plus as an example to illustrate the statistical process: 1) After opening the Image Pro Plus software, open the SEM section topography image of a single particle by following File (F), Open (O) or using the shortcut ctrl+O; 2) Perform scale calibration in Measure (M), Calibration (C), and Spatial Calibration Wizard; 3) Click Irregular AOI and draw the outline of the single particle in Trace mode; 4) Click Measure (M) and Count/Size, select Select Colors . . . , choose Histogram Based, select the range of 0-255, click Count to fill the selected area, then click View, Statistics and record the area of the single particle at the Sum position; 5) In RGB mode, use the extractor to extract the RGB value of the pore, then click Count for identification; click Draw/Merge Objects in Edit to select the unfilled pores, click OK after selection, then click View, Statistics and record the area value at the Sum position, which is the pore area of the single particle; 6) Click Measure (M), Measure Distance, draw a line parallel to the scale, and move this line segment to the area selected by AOI to obtain the transverse median line (maximum length of the line segment); then click Measure Distance, draw a line segment starting from the endpoint with a length of ½ of the transverse median line on the transverse median line, and draw a longitudinal median line perpendicular to the transverse median line at the midpoint of the transverse median line, which intersects the particle outline; 7) Take the center of the transverse median line as the center of the ellipse, with the major axis of the ellipse being ½ of the length of the transverse median line and the minor axis being ½ of the length of the short side of the longitudinal median line; first use Measure Distance to mark the length range, then use Elliptical AOI to draw an ellipse at the marked position as the central region; 8) Repeat steps 4) and 5) to count the area and pore area of the central region; 9) Calculate the area and pore area of the edge region based on the particle area, particle pore area, central region area and central region pore area, and calculate the pore area percent φⱼ of the core section of the single particle, the pore area percent φₐⱼ of the central region, the pore area percent φ_{bj} of the edge region, and the ratio (Aⱼ) of the pore area percents of the central region to the edge region; 10) Perform steps 1)-9) for 20 particles, and calculate the A value and φ value of the anode material using the above formulas.

2. Test of I_{D}/I_{G}

At least 15 particle sections are selected. A rectangular region with a width of 1 μm to 6 μm and a length of 5 μm to 20 μm (which does not exceed the outline of the particle on the section) is selected on the core section of each particle. Raman scattering spectra of the anode material sections are tested using an InVia model microscopic confocal Raman spectrometer; the selected rectangular regions are tested with a laser wavelength of 532 nm, and the mapping direction is set to first scan horizontally and then vertically. The D peak position of the material is near 1350 cm⁻¹, the G peak position is near 1580 cm⁻¹, and the I_{D}/I_{G} value is the intensity ratio of the D peak to the G peak. A schematic diagram of the Raman mapping region of a single particle section and a schematic diagram of rectangular region selection are shown in FIG. 1.

The specific operation for selecting the rectangular region is as follows: 1) Select a particle section where the longitudinal length is greater than the transverse length (if the particle does not meet the requirement, the stage can be rotated before selection); 2) In a single particle, select a rectangular frame that includes the longest longitudinal diameter, with a width of 1 μm to 6 μm and a length approximately between ⅗ and 1 times the length of the longest longitudinal diameter, and at least two points close to the outline of the particle on the section. The longest longitudinal diameter refers to the longest longitudinal distance on the particle section with the test interface as the reference;

3) When processing Raman data, it is first necessary to determine whether the rectangular region meets the requirement of including the longest longitudinal diameter, and the operation is as follows: 3.1) After opening the Image Pro Plus software, open the SEM section topography image of a single particle by following File (F), Open (O) or using the shortcut ctrl+O; 3.2) Click Irregular AOI and draw the outline of the single particle in Trace mode; 3.4) Click Measure (M), Measure Distance, draw a line perpendicular to the scale, and move this line segment to the area selected by AOI, where it intersects the particle outline, thereby obtaining the position of the longest longitudinal diameter (the maximum number of pixels of the line segment; the midpoint of the longest longitudinal diameter is regarded as the center of the section). Then determine whether the selected rectangular frame includes the longest longitudinal diameter; if not, exclude the Raman data of this particle. In total, Raman data of at least 15 qualified particle sections are tested and screened.

Raman mapping data processing is performed on the qualified rectangular regions; according to data classification, the mapping regions are divided into an inner rectangular region a and an outer rectangular region b. Wherein, when the mapping direction is set to first scan horizontally and then vertically as the scanning rule, after arranging the Raman mapping data in chronological order, the first ¼ and the last ¼ of the data are regarded as the Raman data of the outer rectangular region b, and the middle part is regarded as the Raman data of the inner rectangular region a. Peak fitting is performed on the Raman scattering spectrum of each point to determine the characteristic peaks of the material; the D peak position is near 1350 cm⁻¹, and the G peak position is near 1580 cm⁻¹. The intensity ratio (I_{D}/I_{G}) of the D peak to the G peak in the inner rectangular region a and the outer rectangular region b of each particle is calculated, where Kₐᵢ is the I_{D}/I_{G} in the inner rectangular region of the i^{th} particle, and K_{bi} is the I_{D}/I_{G} in the outer rectangular region of the i^{th} particle.

An average value (Kₐ) of I_{D}/I_{G} in the inner layer region, and an average ratio (K) of I_{D}/I_{G} values of the inner layer region to the outer layer region are calculated by:

$${K}_{a} = 1 / n ( {\sum }_{i = 1}^{n} {K}_{ai} )$$

$${K}_{i} = {K}_{ai} / {K}_{bi}$$

$$K = 1 / n ( {\sum }_{i = 1}^{n} {K}_{i} )$$

where n≥15 and 1≤i≤n, and i and n are positive integers.

### 3. Test of Specific Surface Area (SSA)

A JW-DX dynamic specific surface area analyzer device is used to test the specific surface area of the anode material. Based on related theories of physical adsorption, the specific surface area of a solid is determined by taking the continuous flow method proposed by Nelsen and Eggertsen as a structure. A mixed gas of hydrogen as a carrier and nitrogen as adsorbed gas is introduced into a sample tube. When the sample tube is immersed in liquid nitrogen and a low-temperature environment is reached, the nitrogen in the mixed gas will be physically adsorbed by the sample until the sample is saturated. At this time, a proportion of the nitrogen in the mixed gas will be changed, and in the adsorption process, a high-precision thermal conductivity detection instrument will complete detection and calculation.

### 4. Test of D50 Particle Size

The D50 particle size of the anode material is tested by a Malvern 3000 laser particle analyzer. A sample, a small amount of dispersant (a mixed solution of ethanol, pure water and a low foaming surfactant) and pure water are added into a 50 mL beaker, and stirred with a glass rod to uniformly disperse the sample. Then, the sample is transferred into a sample pool of the Malvern 3000 laser particle analyzer, and a particle size test is conducted with a rotation speed of a device pump set to 2400 r/min to 2500 r/min and a frequency at 19.5 Hz. This application pertains to the statistics of volume cumulative particle size distribution.

### 5. Test of Tap Density Tap

A Quantachrome Dual Autotap device is used for a tap density test on the anode material. First, 100 mL of an anode material sample is placed into a measuring cylinder and mechanically vibrated for 1000 times, to obtain a mass and a volume after tapping of the sample, and then, the tap density is calculated by tap density (g/cm³)=sample mass/volume after tapping.

### 6. Test of Average Pore Diameter d

A BSD-660M A6M is used to test the average pore diameter d of the anode material. The test is performed by degassing at 300° C. for 300 minutes in a static capacity method with nitrogen (77.3K) as an adsorbate, and then the amount of adsorbed nitrogen at different pressures (P/P0 in the range of 0.1-0.99) are measured. Then, the average pore diameter d of the anode material may be determined by analyzing an adsorption isotherm.

### 7. Test of Electrochemical Performance

The anode material, carboxymethyl cellulose and styrene-butadiene rubber in each of the examples and the comparative examples are dissolved in water according to a mass ratio of 96.5:1.5:2, with a solid content controlled to 50%, to obtain anode slurry. Then the anode slurry is coated on a copper foil current collector, and dried in vacuum, rolled and pressurized at 95° C. to obtain an anode sheet. A metal lithium sheet is used as a counter electrode and assembled with the anode sheet into a button cell in a glove box filled with argon.

Charge-discharge tests are performed on the button cell at a current density of 0.1C with a charge-discharge interval of 0.01V to 1.5V, to obtain a first reversible specific capacity, a first-cycle charge capacity and a first-cycle discharge capacity, and the initial coulombic efficiency (ICE) is calculated by initial coulombic efficiency=first-cycle discharge capacity/first-cycle charge capacity.

A test of the expansion rate of the electrode sheet is performed by the device and system for measuring thickness changes of a battery electrode sheet disclosed in the patent document CN209991940U. An anode material, carboxymethyl cellulose and styrene butadiene rubber are mixed uniformly according to a mass ratio of 96.5:1.5:2, with a solid content controlled to 50%, to obtain anode slurry. Then the anode slurry is coated on a copper foil current collector, and dried in vacuum and rolled to obtain an anode sheet with a compaction density of 1.60 g/cm³, and then an initial thickness d₁ of the anode sheet is tested. A cathode active substance lithium cobaltate, conductive carbon black and the polyvinylidene fluoride are uniformly mixed according to a mass ratio of 96.5:2:1.5, and coated on an aluminum foil (single surface) to obtain a cathode sheet. The cathode sheet and anode sheet prepared above are loaded into a self-made three-electrode testing device for testing, where the three-electrode testing device can record the thickness change conditions of the electrode sheets in situ.

The test is performed according to following charge-discharge regime: charging at constant rate of 0.01C for 30 minutes in a first cycle, charging at a constant rate of 0.05C for 30 minutes and then charging at a constant rate of 0.1C to 4.2V, charging at a constant voltage when the voltage reaches the upper limit of 4.2V, gradually reducing the current to 0.01C and ending the charging, and then discharging at 0.1C to 3V; in cycle 2, charging at a constant rate of 0.2C to 4.2V; and gradually reducing the current to 0.01C when the voltage reaches 4.2V and ending the charging, and discharging at a constant rate of 0.2C to 3V; in cycles 3 to 20, charging at a constant rate of 0.5C to 4.2V, charging at a constant voltage when the voltage reaches 4.2V, reducing the current to 0.01C and ending the charging, and discharging at a constant rate of 0.5C to 3V; and in a final half cycle, charging at a constant rate of 0.5C to 4.2V, charging at a constant voltage when the voltage reaches 4.2V, reducing the current to 0.01C and ending the process, and disassembling the battery to test the a thickness d₂ of the anode sheet after 20 cycles. The expansion rate of the electrode sheet is calculated by electrode sheet expansion rate=(d₂−d₁)/d₁×100%.

TABLE 1

| | | | | | | | | | | | Electrode |
|---|---|---|---|---|---|---|---|---|---|---|---|
| | | | | | | | | | | | sheet |
| | | | | | | | | | | | expansion |
| | | | | | | | | | | | rate after |
| | D50 | SSA | d | Tap | | | A | | Capacity | ICE | 20 cycles |
| No | μm | m²/g | μm | g/cm³ | K | Kₐ | (φₐ/φ_{b}) | φ_{%} | mAh/g | % | % |
| Example 1 | 16.7 | 2.57 | 13.37 | 1.10 | 0.80 | 0.59 | 1.36 | 2.72 | 362.9 | 94.57 | 24.1 |
| Example 2 | 16.7 | 2.98 | 14.83 | 1.09 | 0.68 | 0.51 | 1.82 | 2.99 | 363.1 | 94.43 | 24.9 |
| Example 3 | 16.9 | 3.81 | 18.53 | 1.04 | 0.54 | 0.43 | 1.68 | 4.92 | 363.8 | 94.28 | 25.9 |
| Example 4 | 15.5 | 2.48 | 13.69 | 1.17 | 0.88 | 0.68 | 1.26 | 2.21 | 362.7 | 94.92 | 22.4 |
| Example 5 | 12.6 | 3.41 | 16.61 | 0.94 | 0.75 | 0.52 | 1.47 | 3.34 | 363.1 | 94.35 | 24.7 |
| Example 6 | 10.6 | 2.96 | 14.81 | 1.02 | 0.84 | 0.62 | 1.33 | 2.84 | 363.2 | 94.12 | 23.2 |
| Example 7 | 16.6 | 3.95 | 19.02 | 1.01 | 0.51 | 0.41 | 2.14 | 4.62 | 363.9 | 93.87 | 26.5 |
| Example 8 | 16.7 | 3.54 | 16.97 | 1.04 | 0.84 | 0.66 | 1.97 | 5.62 | 362.6 | 93.76 | 26.9 |
| Example 9 | 16.6 | 4.03 | 19.56 | 1.06 | 0.86 | 0.68 | 2.26 | 5.88 | 362.1 | 93.57 | 27.3 |
| Comparative | 16.5 | 2.85 | 14.38 | 1.00 | 0.30 | 0.28 | 0.98 | 8.87 | 361.5 | 92.63 | 31.2 |
| example 1 | | | | | | | | | | | |
| Comparative | 16.5 | 2.76 | 14.22 | 1.04 | 0.54 | 0.33 | 1.03 | 7.95 | 362.7 | 93.58 | 28.8 |
| example 2 | | | | | | | | | | | |
| Comparative | 16.6 | 2.63 | 14.95 | 1.13 | 0.94 | 0.34 | 1.64 | 4.25 | 361.8 | 93.66 | 27.7 |
| example 3 | | | | | | | | | | | |

In table 1, d is an average pore diameter of the anode material.

As can be seen from table 1, in the anode materials of examples 1 to 9, the graphite is filled with amorphous carbon, and each of the examples satisfies 0.4≤Kₐ≤0.7, and 0.5≤K<0.9, while neither of comparative examples 1 and 3 satisfies 0.5≤K≤0.9 or 0.4≤Kₐ≤0.7, and the anode material of comparative example 2 only satisfies 0.5≤K≤0.9, but not 0.4≤Kₐ≤0.7. The anode materials of examples 1 to 9 have higher initial coulombic efficiencies, reduced expansion rates, and higher capacities compared with those in comparative examples 1 to 3. Therefore, the anode material of the present application, which satisfies 0.4≤Kₐ≤0.7, and 0.5≤K<0.9, can reduce the structural expansion caused by Li⁺ entering and exiting the graphite layers, thereby improving the structural stability of the material, as well as the initial coulombic efficiency, the expansion performance and the capacity.

Further, compared with those in examples 7, 8 and 9, the anode materials of examples 1 to 6, while satisfying 0.5≤K≤0.9 or 0.4≤Ka≤0.7, further have a pore area percent φ of the core satisfying: 2%≤φ≤5%, and further an average ratio A of pore area percents of the inner layer region to the outer layer region satisfying 1.2≤A≤2.0, thereby further improving the initial coulombic efficiency, the expansion performance and the capacity. The anode material of example 9 does not satisfy 2%≤φ≤5%, so that the improvement in the electrochemical performance of the anode material is limited, and the performance is poorer than those in examples 1 to 6. The anode material of example 7 does not satisfy 1.2≤A≤2.0, and the anode material of example 8 does not satisfy 2%≤φ≤5%, so that the improvement in the electrochemical performance of the anode material is limited, and the performance is poorer than that of examples 1 to 6. The anode material of example 9 does not satisfy 2%≤φ≤5% or 1.2≤A≤2.0, leading to a poorer performance than those in examples 7 to 8.

In examples 1 to 6, coating is performed in batches, and the steps of low-temperature heat treatment, pressing, high-temperature heat treatment and the like are adopted to fill amorphous carbon into particles. Therefore, internal defects of the particles are improved, pores in both the inner and outer layer regions, especially pores in the outer layer region, are filled, so that the material satisfies 0.5≤K≤0.9, 0.4≤Ka≤0.7, 1.2≤A≤2.0, and 2%≤φ≤5%. Such a graphite anode material has the advantages of high compactness and low expansion, and can be applied to a secondary lithium-ion battery to achieve excellent electrochemical performance. In comparative example 1, amorphous carbon is filled into the graphite, and the material satisfies none of 0.5≤K≤0.9, 0.4≤Ka≤0.7, 1.2≤A≤2.0, or 2%≤φ≤5%, resulting in lower initial coulombic efficiency, lower capacity and poorer expansion performance of the anode material. In comparative example 2, a small amount of graphene is introduced, so that the material satisfies 0.5≤K≤0.9, but still does not satisfy 0.4≤Ka≤0.7, 1.2≤A≤2.0, or 2%≤φ≤5%. Therefore, the initial coulombic efficiency, capacity and expansion performance are improved compared with those in comparative example 1, but the improvements are limited. In comparative example 3, pores inside the graphite are firstly reduce by a densification process prior to coating with pitch, but amorphous carbon cannot be filled into the graphite to the maximum extent, resulting in the anode material satisfying 1.2≤A≤2.0, and 2%≤φ≤5%, but still not satisfying 0.5≤K≤0.9 or 0.4≤Ka≤0.7. Therefore, the initial coulombic efficiency, and expansion performance are improved compared with those in comparative examples 1 and 2, but the capacity is reduced compared with that in comparative example 2, and the improvements are limited.

The descriptions above are merely preferred embodiments of the present application, which are not used to limit the present application. For those skilled in the art, the present application may have various changes and variations. Any modification, equivalent replacement, improvement or the like made within the spirit and principle of the present application shall be included in the protection scope of the present application.

What is claimed is:

1. An anode material comprising:
a core comprising natural graphite having pores and first amorphous carbon filled in the pores; and
a coating layer located on a surface of the core, the coating layer comprising second amorphous carbon,
wherein a Raman spectrum of the anode material has a D peak and a G peak, and an intensity ratio of the D peak to the G peak is I_{D}/I_{G};
the core includes an inner layer region and an outer layer region outside the inner layer region, and the outer layer region is closely adjacent to the coating layer; and
an average value of I_{D}/I_{G} in the inner layer region is Kₐ, and an average ratio of I_{D}/I_{G} values of the inner layer region to the outer layer region is K, which satisfy: 0.4≤Kₐ≤0.7, and 0.5≤K<0.9.

2. The anode material of claim 1, wherein the anode material satisfies:
$$0.41 \leq Ka \leq 0.68 ; or$$
$$0.4 \leq Ka \leq 0.6 ; or$$
$$0.45 \leq Ka \leq 0.7 ; or$$
the value of Ka is 0.4, 0.41, 0.45, 0.5, 0.55, 0.6, 0.65, 0.68, 0.7, or a range defined by any two of the aforementioned values.

3. The anode material of claim 1, wherein the anode material satisfies:
$$0.51 \leq K \leq 0.88 ; or$$
$$0.5 \leq K \leq 0.89 ; or$$
$$0.6 \leq K \leq 0.8 ; or ,$$
the value of K is 0.5, 0.51, 0.6, 0.7, 0.8, 0.88, 0.89, or a range defined by any two of the aforementioned values.

4. The anode material of claim 1, wherein the core has a pore area percent φ satisfying: 2%≤φ≤5%.

5. The anode material of claim 4, wherein the anode material satisfies:
$$2 \% \leq φ \leq 5 \% ; or$$
$$3 \% \leq φ \leq 5 \% ; or$$
$$2 \% \leq φ \leq 4 \% ; or$$
the value of φ is 2%, 2.5%, 3%, 4%, 4.5%, 5%, or a range defined by any two of the aforementioned values.

6. The anode material of claim 4, wherein the core includes a central region and an edge region located on the periphery of the central region; and an average ratio of pore area percents of the central region to the edge region is A, which satisfies: 1.2≤A≤2.0.

7. The anode material of claim 6, wherein the anode material satisfies:
$$1.2 \leq A \leq 1.8 ; or$$
$$1.2 \leq A \leq 1.6 ; or$$
$$1.4 \leq A \leq 1.9 ; or$$
the value of A is 1.2, 1.3, 1.4, 1.5, 1.6, 1.7, 1.8, 1.9, 2.0, or a range defined by any two of the aforementioned values.

8. The anode material of claim 1, wherein the anode material has a D50 particle size of 5 μm to 20 μm.

9. The anode material of claim 4, wherein the anode material has a D50 particle size of 5 μm to 20 μm.

10. The anode material of claim 1, wherein the anode material has a shape including at least one of a spherical shape, an ellipsoidal shape, or a spheroidal shape.

11. The anode material of claim 1, wherein the anode material has a specific surface area of 2 m²/g to 5 m²/g.

12. The anode material of claim 4, wherein the anode material has a specific surface area of 2 m²/g to 5 m²/g.

13. The anode material of claim 1, wherein the anode material has a tap density of 0.9 g/cm³ to 1.4 g/cm³.

14. The anode material of claim 4, wherein the anode material has a tap density of 0.9 g/cm³ to 1.4 g/cm³.

15. The anode material of claim 1, wherein the anode material has an average pore diameter of 10 nm to 20 nm.

16. The anode material of claim 4, wherein the anode material has an average pore diameter of 10 nm to 20 nm.

17. The anode material of claim 1, wherein the thickness of the coating layer is 2 nm to 100 nm.

18. The anode material of claim 4, wherein the thickness of the coating layer is 2 nm to 100 nm.

19. An anode sheet comprising:
an anode current collector; and
an anode material active layer comprising the anode material of claim 1 at least one surface of the anode current collector.

20. A secondary battery comprising:
a cathode sheet;
the anode sheet of claim 19; and
an isolation film between the cathode sheet and the anode sheet.
